(19) United States
(12) Patent Application Publication
(10) Pub. No.: US 2014/0029864 A1
(43) Pub. Date: Jan. 30, 2014

(54) COMPRESSION ENCODING AND DECODING METHOD AND APPARATUS

(71) Applicant: Dror Reif, Be'er-Yacoov (IL)

(72) Inventor: Dror Reif, Be'er-Yacoov (IL)

(21) Appl. No.: 13/561,382

(22) Filed: Jul. 30, 2012

(51) Int. Cl. G06K 9/36

(52) U.S. Cl. 382/238; 382/232

(57) ABSTRACT

A compression encoding technique receives a series of data values each represented by a constant number of bits, divides the series into group, and for each group, determines a minimum number of bits that is sufficiently large to encode each of the data values without a loss in data, based on a property of the data values that is common within the group. The technique encodes the data values into encoded data values each represented by the determined minimum number of bits. The technique also appends to each encoded group a data descriptor indicating the determined number of bits used to encode the members of the group.

### BACKGROUND

Image sensors capture images with ever increasing resolution and, correspondingly, produce ever increasing amounts of captured image data, e.g., pixels. This increase in data drives costly increases in transmission bandwidth for transmitting the data, memory capacity to store the data, and computing power to process the data. To reduce such costs, the data may be compressed using known compression techniques, such as Huffman coding and Rice coding. Disadvantageously, Huffman coding requires computationally complex translation tables, which complicate encode and decode access to the tables and may be difficult to implement in hardware. On the other hand, Rice coding eliminates the translation tables associated with Huffman coding, but, in some cases, results in greatly expanded coding results or values, which reduces coding efficiency and compression gain. Accordingly, known data compression techniques are either overly complex or produce inconsistent compression gain results.

### BRIEF DESCRIPTION OF THE DRAWINGS/FIGURES

FIG. 1 is a block diagram of an example system for efficient lossless compression encoding and lossless decompression decoding of a data signal, according to an embodiment.

FIG. 2 is a block diagram of a compression encoder from FIG. 1, according to an embodiment.

FIG. 3 is an illustration of exemplary binary encoding data compression performed by the compression encoder of FIG. 2.

FIG. 4 is a block diagram of a decompression decoder of FIG. 1, according to an embodiment.

FIG. 5 is a block diagram of an example image compression/decompression encoding/decoding system, including a front-end to capture and compress a full color image/scene, and a back-end to decompress the compressed image and prepare the decompressed image for display.

FIG. 5A is a block diagram of a predictor of FIG. 5, according to an embodiment.

FIG. 5B is a block diagram of an inverse predictor of FIG. 5, according to an embodiment.

FIG. 6 is a block diagram of an example compressor for compressing Bayer-formatted image pixels.

FIG. 7 is a block diagram of an example decompressor for decompressing compressed sub-images from FIG. 6.

FIG. 8 is a flow chart of an example method of compression encoding.

FIG. 9A is a flow chart of an example method expanding on the determining of the method of FIG. 8, for a binary encoding embodiment.

FIG. 9B is a flow chart of an example method expanding on the determining at of the method of FIG. 8, for a Rice encoding embodiment.

FIG. 9C is a flow chart of an example method of compression encoding for a combined encoding embodiment.

FIG. 10 is a flow chart of an example method of decompression decoding.

FIG. 11 is a block diagram of a computer system, configured to perform compression encoding and decompression decoding.

FIG. 12 is a block diagram of a system including a system for compression encoding and decompression decoding of signals.

In the drawings, the leftmost digit(s) of a reference number identifies the drawing in which the reference number first appears.

### DETAILED DESCRIPTION

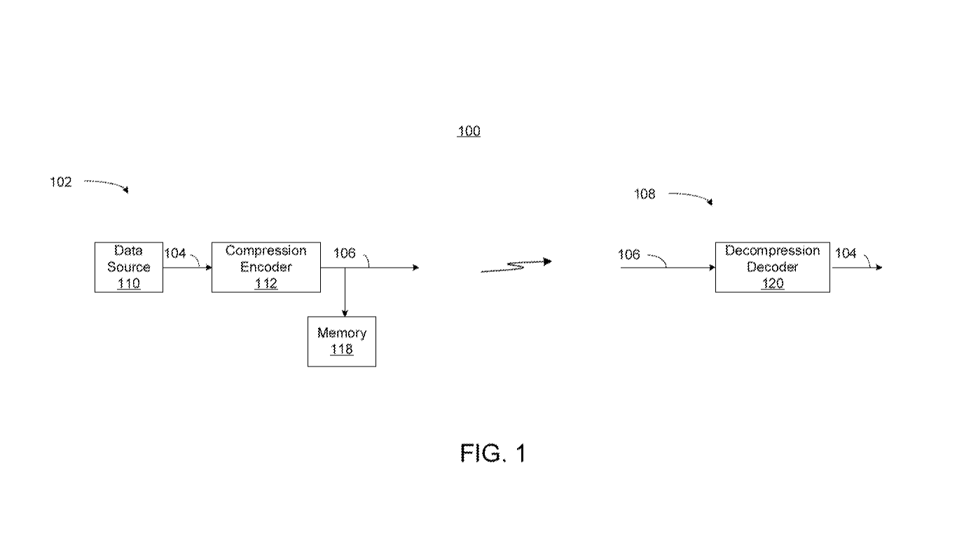

FIG. 1 is a block diagram of an example system 100 for efficient lossless compression encoding and lossless decompression decoding of a data signal, according to an embodiment. System 100 includes a front-end 102 to compress a data signal 104 into a compressed data signal 106, and a back-end 108 to decompress data signal 106, and thereby recover data signal 104.

Front-end 102 includes a data source 110 followed by a lossless compression encoder 112. Data source 110 may produce data signal 104 as a series of data values or data elements. Accordingly, data signal 104 is alternatively and equivalently referred to herein as “data values 104.” Data source 110 may include, for example, a signal quantizer to produce data signal 104 as a series of quantized signal data values, an image sensor to produce a series of image pixels, a predictor to produce a series of error values, and/or a memory to store the data values and from which the data values may be accessed.

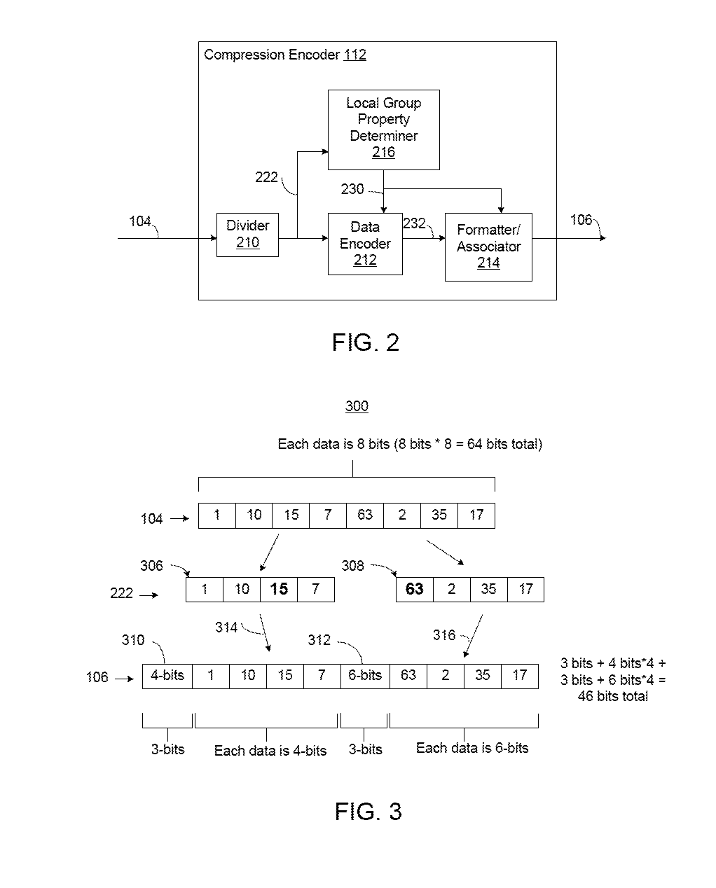

As will be described in more detail below, compression encoder 112 encodes each of data values 104 into a corresponding encoded data value in a lossless manner, i.e., without a loss in data, to produce a series of encoded data values carried in compressed data signal 106. Compression encoder 112 is said to compress data signal 104 because a total number of bits used to represent corresponding compressed data signal 106 is substantially less than a total number of bits used to represent the data signal 104, as will become apparent from the description below in connection with FIG. 2. Compression encoder 112 may store compressed data signal 106 in a local memory 118, and/or transmit the compressed data signal to back-end 108 through a wired or wireless communication channel.

Back-end 108 may access compressed data signal 106 from memory 118 or receive the compressed data signal through the communication channel. Back-end 108 includes a lossless decompression decoder 120 to decompress compressed data signal 106 without a loss in data, to recover data signal 104, fully. Decompression decoder 120 produces a series of decoded data signal values representing data signal 104.

FIG. 2 is a block diagram of compression encoder 112, according to an embodiment. Compression encoder 112 receives data values 128, each of which has a magnitude or value represented by a fixed field width, i.e., a constant number of bits, of, e.g., an 8-bit byte, or a 16-bit word, etc. Compression encoder 116 includes a divider 210, a data encoder 212, a formatter/associator 214, and a local group property determiner 216 (also referred to as a determiner 216), which cooperate to encode each of the data values in data signal 104 into a corresponding encoded data value, without a loss in data, to produce the series of encoded data values represented in compressed data signal 106.

Divider 210 divides data values 104 into sequential groups of data values 222, where each group includes N data values. N may be a predetermined integer greater than one, such as in the exemplary range of 5 to 10, and may be fixed across the groups. Alternatively, N may vary across the groups.

Determiner 216 has an a priori knowledge of one or more types of encoding, i.e., data encoding techniques, to be performed by data encoder 212 to encode data values 104 in the groups of data values 222. Exemplary encoding techniques include, but are not limited to, binary encoding and Rice encoding. Determiner 216 examines the N data values in each of the groups 222 independently of the other groups, to determine a local property, i.e., an intra-group property, that is common among the N data values in the given group and that is to be used to data encode each of those values. In other words, determiner 216 determines a local property of the N data values to be used to encode each of the data values. The determined local property is fixed for each group, but varies across the groups according to the data values. Exemplary local properties include, but are not limited to, a minimum number of bits used to represent binary encoded data values, or a Rice-Golomb parameter used to Rice encode the data values.

Determiner 216 provides, to both data encoder 212 and formatter/associator 214, data descriptors 230 indicating (i) the local property determined for each group, and, in some embodiments, (ii) the type of encoding to be performed by data encoder 212 (e.g., binary encoding, or Rice encoding) based on the determined local property.

Using the data descriptors 230, data encoder 212 encodes each data value in each group of data values 222 into a corresponding encoded data value. Accordingly, data encoder 212 produces a series of encoded data values 232, including sequential groups of encoded data values corresponding to the sequential groups of data values 222. Encoding groups of data values as described herein, i.e., based on the corresponding local property of each group, typically achieves a higher compression gain (e.g., a ratio of a number of bits used to represent data signal 104 to a number of bits used to represent compressed data signal 106) than simply encoding the data values based on a property that is not local to each group, i.e., that is common across the entire data signal 104. This is because compression gain is maximized on a group by group basis, according to the data values in any given group.

Formatter/associator 214 associates with each of the groups of encoded data values 232 the corresponding one of data descriptors 230 indicating the determined local property used to produce the encoded data values. For example, formatter/associator 214 may append the determined local property to a beginning of the corresponding group of encoded data values in encoded data values 232, to produce compressed data signal 106, i.e., compressed data signal 106 includes the encoded data values 232 and embedded data descriptors 230. In an alternative embodiment, data descriptors 230 are not embedded in compressed data signal 106, but rather are provided separately from encoded data values 232, e.g., in an out-of-band channel. The data descriptors 230 are used at back-end 108 to decode their associated groups of encoded data values.

Several embodiments of compression encoder 112 are now described, including binary encoding, Rice encoding, and combined binary and Rice encoding embodiments.

The binary encoding embodiment is described with reference to both FIGS. 2 and 3. FIG. 3 is an illustration of exemplary binary encoding data compression 300 performed by compression encoder 112. In this embodiment (i) data encoder 212 performs binary encoding of data values 104, e.g., data encoder 212 encodes exemplary data values 2, 3, 4, and 5 as binary codes 10, 11, 100, and 101, respectively, and (ii) determiner 216 determines, as the local property of each group of N data values, a minimum number of bits to binary encode each of the data values in the given group without any loss in data. The determined number of bits will vary across the successive groups 222 as the data values in the groups vary.

Depicted at the top of FIG. 3 is an example series of eight, 8-bit data values 104. Exemplary data values 104 are represented by a total of 64 bits. Divider 210 divides the series of data values 104 into first and second sequential groups of 4 data values 306 and 308 (of signal 222), respectively.

Determiner 216 determines the minimum number of bits (i.e., the local property) in the following manner. First, determiner 216 determines the maximum data values 15 (binary 1111), 63 (binary 111111) in groups 306, 308, respectively. Assuming binary encoding, i.e., that the data values in each group will be encoded as binary values, determiner 216 then determines, as the local property, the minimum numbers of bits as 4-bits, 6-bits to binary encode the maximums 15, 63 without a loss in data, e.g., without truncation, rounding, quantization, etc. Determiner 216 provides data descriptors 230, which include the determined 4-bit and 6-bit descriptors, to data encoder 212 and formatter/associator 214.

Based on the “4-bit” and “6-bit” data descriptors, data encoder 212 binary encodes each of the data values in group 306 into a respective 4-bit field, and each of the data values in group 308 into a respective 6-bit field.

Formatter/associator 214 appends the data descriptors 310 (4-bit) and 312 (6-bit), in 3-bit binary encoded fields, to each of the groups of encoded data values 314, 316 corresponding to groups 306, 308, respectively, to produce exemplary compressed data signal 106. Exemplary compressed data signal 106 is represented in a total of 46 bits, which is substantially less than the 64 bits required to represent data values 104.

The Rice encoding embodiment is now described. In this embodiment data encoder 212 Rice encodes each of data values 104, X, as a code word <q, r,>, where

X is the data value to be encoded,

q (quotient)=int[X/M], and

r (remainder)=X modulo M.

M is referred to as the Rice-Golomb parameter, and may be, for example, a median value, or other function, taken over a set of the data values to be encoded.

In the Rice encoding embodiment, determiner 216 determines, as the local property for each given group of data values, the Rice-Golomb parameter M for the given group. That is, the Rice-Golomb parameter M is calculated using only the data values from the given group. Data encoder 212 Rice encodes the given group of data values using the M determined for the given group. Formatter/associator 214 appends the determined M to the group of encoded data values corresponding to the determined M.

The combined binary and Rice encoding embodiment is now described. In the combined binary and Rice encoding embodiment, compression encoder 112 encodes each group of data values using a selected one of binary encoding and Rice encoding (in the manner described above) to achieve a maximum compression gain, i.e., depending on which of the two techniques produces a maximum compression gain for the given group. Determiner 216 determines for each group (i) the minimum number of bits to binary encode the data values in the given group, and (ii) the Rice-Golomb parameter M for the data values. Then, determiner 216 and data encoder 212 operate together to determine which of the binary and Rice encoding techniques, using their respective local properties (i.e., the minimum number and M, respectively), would produce a maximum compression of the data values of the given group, e.g., is a most efficient compression technique. To determine the best technique, data encoder 212 may encode the data values using both techniques, and select the technique requiring the least amount of bits to represent the encoded data values. Formatter/associator 214 appends to the group of encoded data values a descriptor indicating the type of encoding that was selected/determined as the best at compressing the data values, and the corresponding local parameter.

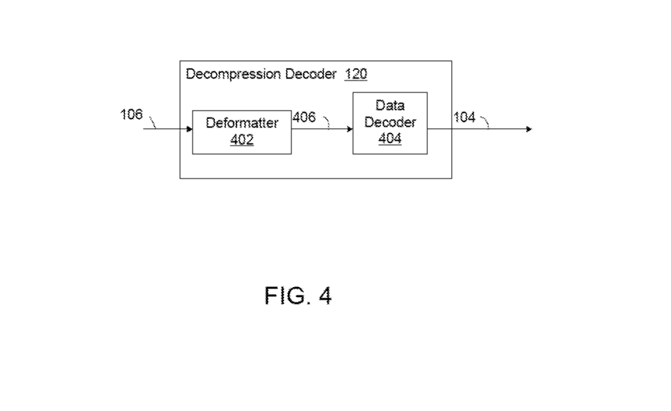

FIG. 4 is a block diagram of decompression decoder 120, according to an embodiment. Decompression decoder 120 includes a deformatter 402 followed by a data decoder 404. Deformatter 402 accesses compressed data signal 106, and recovers the data descriptors 230, e.g., descriptors 310, 312, from the compressed data signal. Deformatter 402 provides to data decoder 404, a data signal 406 including the recovered data descriptors 230 and encoded data values 232 (see FIG. 2) carried in compressed data signal 106. Using the recovered data descriptors 230, data decoder 404 decodes, e.g., binary decodes or Rice decodes, encoded data values 232 in a lossless manner, to produce the series of decoded data values or, simply, data values 104 (See FIG. 1).

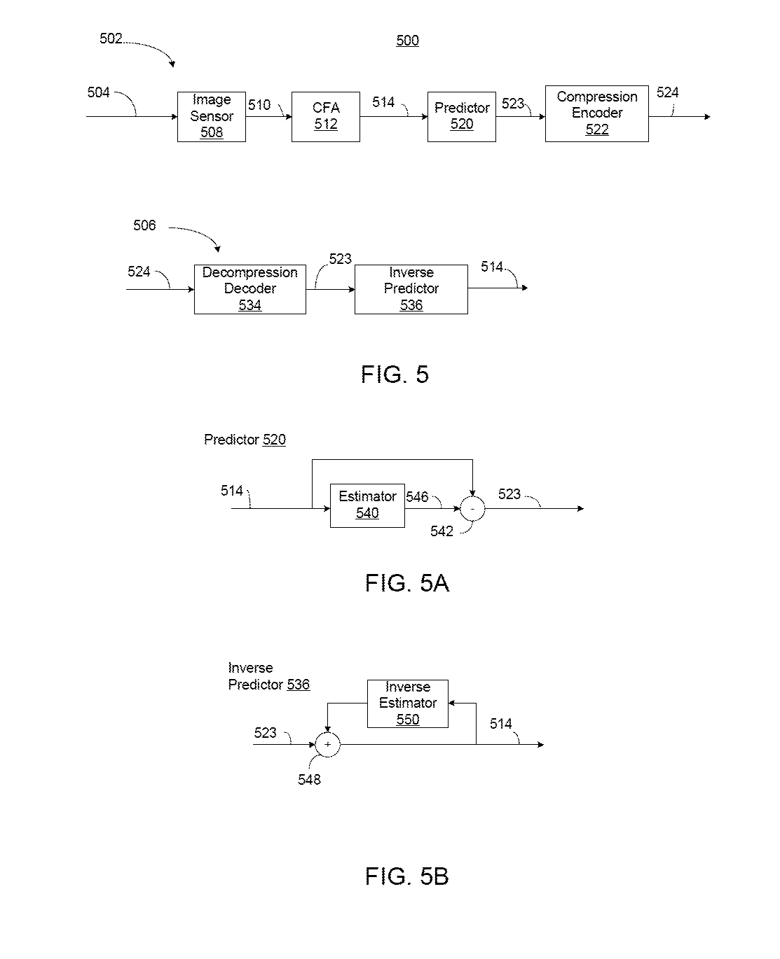

FIG. 5 is a block diagram of an example image compression/decompression encoding/decoding system 500, including a front-end 502 to capture and compress a full color image/scene 504, and a back-end 506 to decompress the compressed image for, e.g., display.

Front-end 502 includes an image sensor 508 to capture/record full color image 504 as an array of full color pixels 510. A color filter array (CFA) 512, such as a Bayer filter, filters the array of pixels 510 to produce an array of filtered pixels 514, e.g., Bayer-formatted pixels, as would be appreciated by those of ordinary skill in the relevant arts. The filtered pixels 514 have values each represented as a fixed number of bits, e.g., 10-bits. In other embodiments, image sensor 508 may produce image data in formats other than the Bayer format, such as in a bitmap image file or BMP file format, a raw image format, grey-scale format, and so on, as would be appreciated by those of ordinary skill in the relevant arts.

Front-end 502 also includes a predictor 520 followed by a compression encoder 522. Predictor 520 predicts each of the pixels 514 to produce a series of pixel prediction errors or residues 523, and provides the prediction errors to compression encoder 522. Prediction errors 523 typically have values that are significantly less than those of pixels 514, thereby increasing data signal compression. Prediction errors 523 correspond to data values 104 described above in connection with FIG. 1.

Compression encoder 522 is configured to operate substantially the same as compression encoder 112 described above in connection with FIG. 2. Accordingly, compression encoder 522 compresses prediction errors 523 into a compressed data signal 524.

Back-end 506 includes a decompression decoder 534 followed by an inverse predictor 536. Decompression decoder 534 is configured to operate substantially the same as decompression decoder 120 described above in connection with FIG. 4. Therefore, decompression decoder recovers prediction errors 523. Inverse predictor 536 operates inversely to predictor 520, to recover pixels 514 from prediction errors 523.

FIG. 5A is a block diagram of predictor 520, according to an embodiment. Predictor 520 includes an estimator 540 followed by a subtractor 542. Estimator 540 estimates pixel values 514 to produce estimated pixel values 546. Subtractor 542 subtracts the estimated pixel values 546 from the corresponding pixel values to produce prediction errors 523. Estimator 540 operates based on an assumption that there is locality in the pixel values, meaning that the value of a current pixel is about the same as that of a previous pixel. Accordingly, the differences represented in prediction errors 523 yield smaller values more frequently than larger values, and, advantageously, the smaller values may be encoded with less bits than the larger values.

FIG. 5B is a block diagram of inverse predictor 536, according to an embodiment. Inverse predictor 536 includes an adder 548 and an inverse estimator 550. Adder 548 outputs a current estimated pixel value 514, which represents a sum of a previous estimated pixel value and a previous prediction error 523.

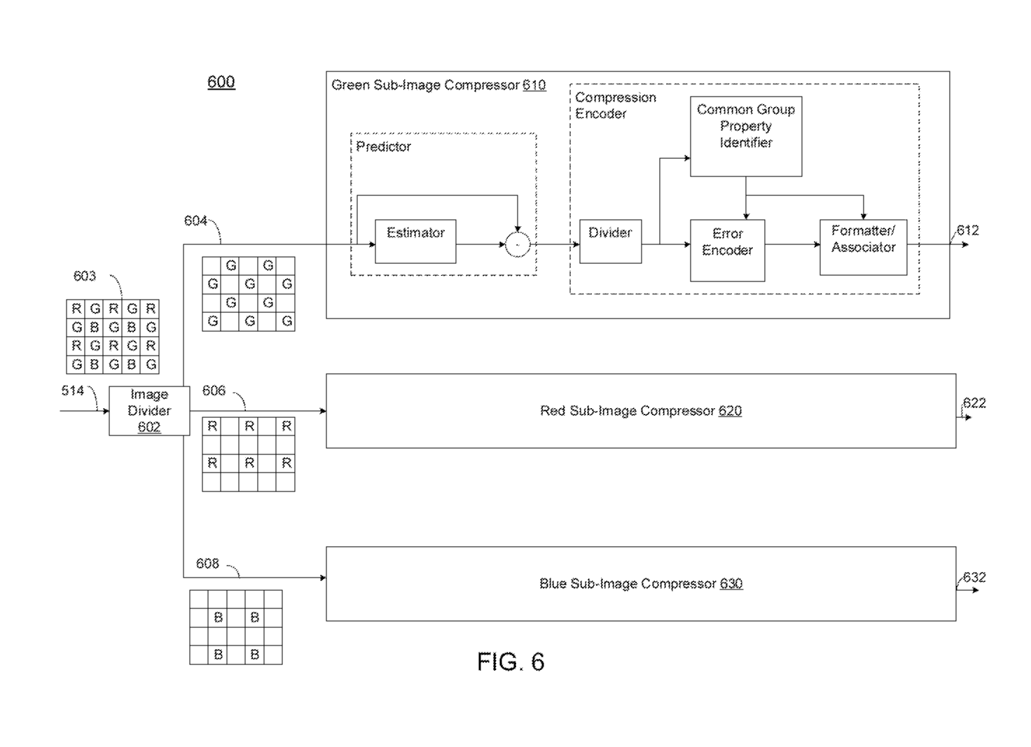

FIG. 6 is a block diagram of an example compressor 600 for compressing Bayer-formatted image pixels. In this example, filtered pixels 514 form an array of Bayer-formatted pixels indicated at 603, including green (G), red (R), and blue (B) pixels (i.e., pixel values).

Compressor 600 includes an image divider 602 to divide filtered pixels 514 (603) into separate sub-images 604, 606, and 608 each containing only green, red, and blue pixels, respectively. In an alternative embodiment, divider 602 may be incorporated into CFA 512. Each of the pixels of the sub-images 604, 606, and 608 corresponds to data values 104 of FIG. 1.

Compressor 600 includes a green sub-image compressor 610 to compress the green sub-image of pixels 604 into a compressed green sub-image 612, which corresponds to compressed data signal 106 of FIG. 1. Green sub-image compressor 610 includes a predictor and a compression encoder each configured to operate substantially the same as their respective counterpart (520, 522) described above in connection with FIGS. 5 and 5A.

Similarly, a red sub-image compressor 620 compresses red sub-image of pixels 606 into a compressed red sub-image 622, and a blue sub-image compressor 630 compresses blue sub-image of pixels 608 into a compressed blue sub-image 632.

In other embodiments, two of sub-images 604, 606, and 608 may be combined and processed together in a corresponding combined sub-image compressor.

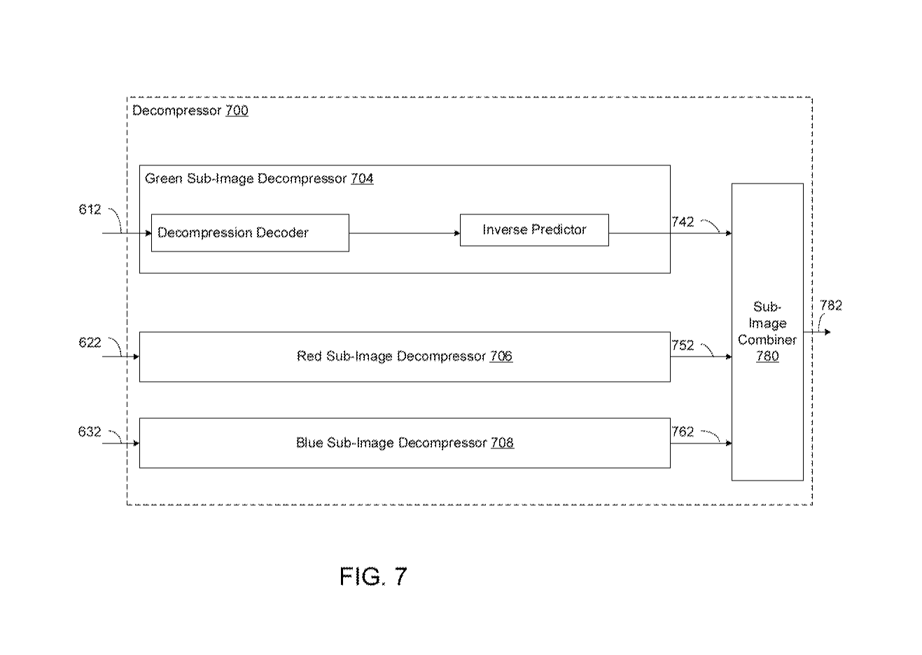

FIG. 7 is a block diagram of an example decompressor 700 for decompressing compressed sub-images 612, 622, and 632 from FIG. 6.

Decompressor 700 includes sub-image decompressors 704, 706, and 708 to decompress sub-images 612, 622, and 632, to produce decompressed red, green, and blue sub-images 742, 752, and 762, respectively. Each of decompressors 704-708 includes a decompression decoder and an inverse predictor each configured to operate substantially the same as their respective counterpart (534, 536) described above in connection with FIGS. 5 and 5B.

Decompressor 700 also includes a sub-image combiner 780 to combine sub-images 742, 752, and 762 into a single image array of pixels 782.

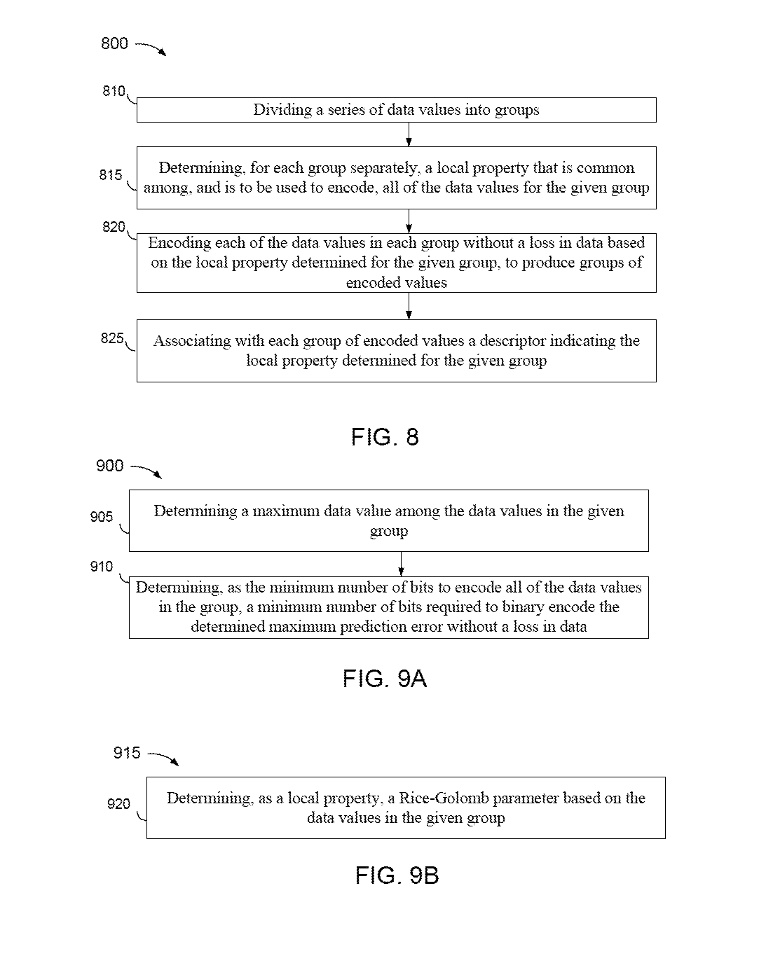

FIG. 8 is a flow chart of an example method 800 of compression encoding.

810 includes dividing a series of data values into groups, where each data value may be represented by a fixed number of bits.

815 includes determining, for each group independent of the other groups, i.e., based on the data values of only the given group, a local property that is common among, and is to be used to encode, all of the data values for the given group.

820 includes encoding each of the data values in each of the groups without a loss in data based on the local property determined for each of the groups, respectively, to produce groups of encoded values.

825 includes associating with each group, e.g., appending to each group, of encoded values from 820 a descriptor indicating the local property determined for the given group. The descriptor may be binary encoded using a minimum number of bits to represent the full value of the descriptor, i.e., without a loss in data.

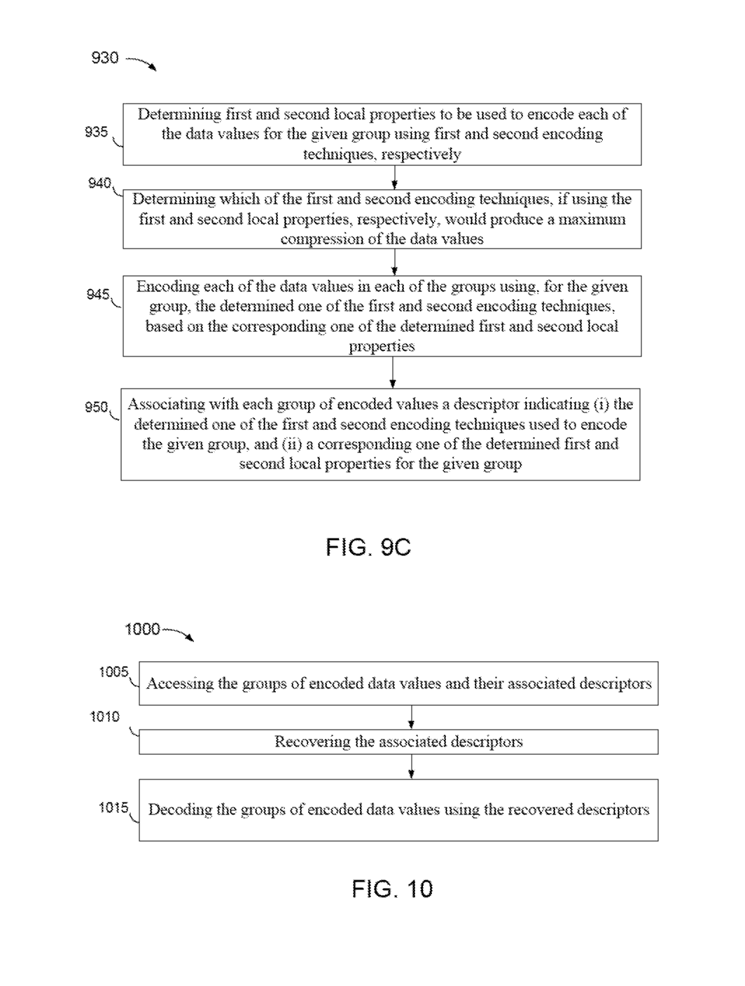

FIG. 9A is a flow chart of an example method 900 expanding on the determining at 815 in method 800, for a binary encoding embodiment. Together, 905 and 910 include determining, as the local property in 815, a minimum number of bits required to binary encode each of the data values in the given group without a loss in data. Typically, the determined minimum number of bits is substantially less than the fixed number of bits used to represent each of the data values from 810.

Specifically, 905 includes determining a maximum data value among the data values in the given group.

910 includes determining, as the minimum number of bits to encode all of the data values in the group (i.e., the local property), a minimum number of bits required to binary encode the determined maximum prediction error without a loss in data.

In this embodiment, the encoding at 820 includes binary encoding each of the data values in the given group into encoded data values each represented by the determined minimum number of bits.

The associating at 825 includes associating the minimum number of bits with the corresponding binary encoded group of data values.

FIG. 9B is a flow chart of an example method 915 expanding on the determining at 815 of method 800, for a Rice encoding embodiment.

920 includes determining, as the local property, a Rice-Golomb parameter M based on the data values in the given group. M may be a median value of all of the data values in the given group.

Then, encoding at 820 includes Rice encoding each of the data values in the given group using the Rice-Golomb parameter, and, at 825, associating M with the group of Rice encoded data values resulting from 820.

FIG. 9C is a flow chart of an example method 930 of compression encoding for a combined encoding embodiment. Method 930 assumes a series of data values has already been divided into groups, e.g., at 810 in method 800, and are ready to be encoded.

935 includes determining first and second local properties (e.g., a minimum number of bits and M) to be used to encode each of the data values for the given group using first and second encoding techniques (e.g., binary encoding and Rice encoding), respectively.

940 includes determining which of the first and second encoding techniques, when using the first and second local properties, respectively, would produce a maximum compression of the data values.

945 includes encoding each of the data values in each of the groups using, for the given group, the determined one of the first and second encoding techniques, based on the corresponding one of the determined first and second local properties.

950 includes associating with each group of encoded values a descriptor indicating (i) the determined one of the first and second encoding techniques used to encode the given group (e.g., the minimum number of bits, or M), and (ii) a corresponding one of the determined first and second local properties for the given group (e.g., binary encoding or Rice encoding).

FIG. 10 is a flow chart of an example method 1000 of decompression decoding.

1005 includes accessing the groups of encoded data values and their associated descriptors produced in method 800.

1010 includes recovering the associated descriptors.

1015 includes decoding the groups of encoded data values using the recovered descriptors.

1020 includes predicting the decoded errors to reproduce their corresponding quantized signal values.

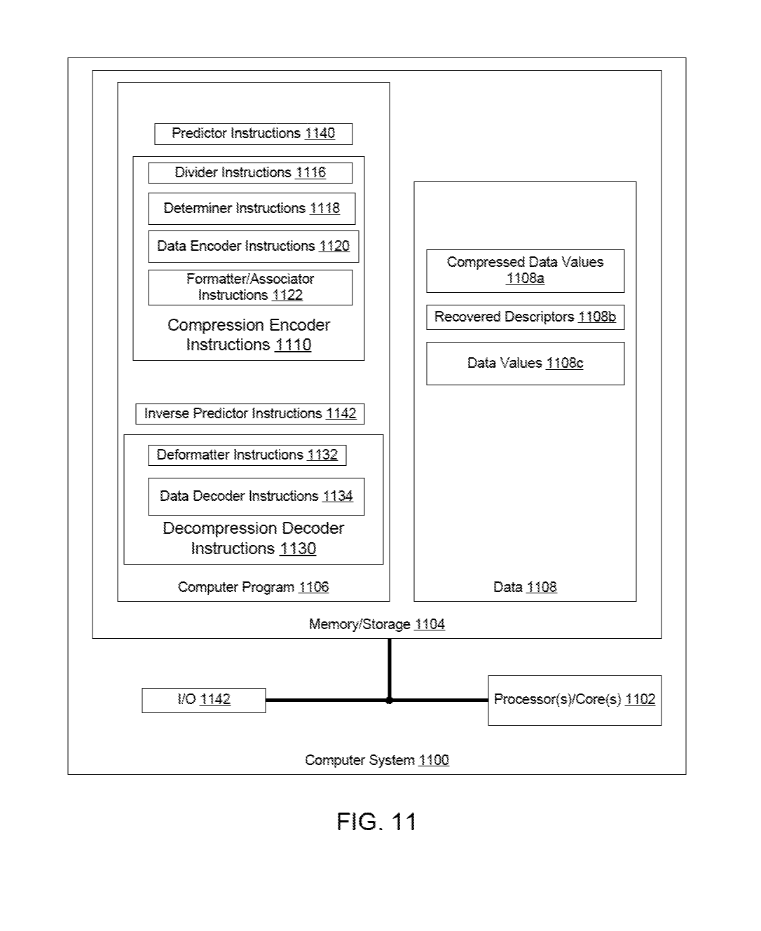

FIG. 11 is a block diagram of a computer system 1100, configured to perform compression encoding and decoding.

Computer system 1100 includes one or more computer instruction processing units and/or processor cores, or microcontrollers, illustrated here as a processor 1102, to execute computer readable instructions, also referred to herein as computer program logic.

Computer system 1100 may include memory, cache, registers, and/or storage, illustrated here as memory 1104, which may include a non-transitory computer readable medium encoded with a computer program, illustrated here as a computer program 1106. Processor 1102 and memory 1104 may communicate with external devices through an input/output port 1142.

Memory 1104 may include data 1108 to be used by processor 1102 in executing computer program 1106, and/or generated by processor 1102 during execution of computer program 1106. Data 1108 may include compressed/encoded data values 1108a, recovered descriptors 1108b, and data values 1108c.

Computer program 1106 may include compression encoder instructions 1110 to cause processor 1102 to compress data values to produce a compressed data signal, such as described in one or more examples above. Instructions 1110 may include:
a. divider instructions 1116 to cause processor 1102 to divide the series of data values into groups;
b. determiner instructions 1118 to cause processor 1102 to determine, for each group, a local property of each group of data values, based on a property of the data values that is common within the group;
c. data encoder instructions 1120 to cause processor 1102 to encode each of the data values in each group into encoded data values based on the determined local property; and
d. formatter/associator instruction 1122 to cause the processor to associate with each of group of the encoded data values a descriptor indicating the determined minimum number of bits by which the encoded data values are represented in the group.

Computer program 1106 may also include decompression decoder instructions 1130 to cause processor 1102 to decompress the compressed data signal produced by compression encoder instructions 1110. Instructions 1130 may include:
a. deformatter instructions 1132 to cause processor 1102 to access the groups of encoded data values and their associated descriptors produced by instructions 1110 and recover the associated descriptors; and
b. data decoder instructions 1134 to cause processor 1102 to decode the groups of encoded data values using the recovered descriptors.

Computer program 1106 may also include predictor instructions 1140 to cause processor 1102 to predict data values to produce a series of predicted error values, and inverse predictor instructions 1142 to cause the processor to perform an inverse operation to that of the instructions 1140.

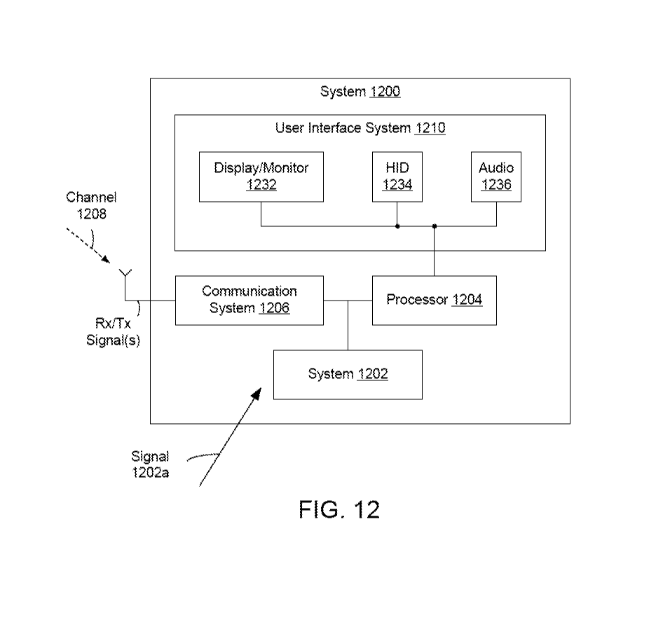

Methods and systems disclosed herein may be implemented with respect to one or more of a variety of systems including one or more consumer systems, such as described below with reference to FIG. 12. Methods and systems disclosed herein are not, however, limited to the example of FIG. 12.

FIG. 12 is a block diagram of a system 1200 including a system 1202 for compression encoding and decompression decoding of signals. System 1202 may be implemented as described in one or more examples herein. System 1202 may capture and compress a signal 1202a, such as an image, to produce a corresponding compressed data signal.

System 1200 may include a processor 1204.

System 1200 may include a communication system 1206 to interface between processor system 1204 and a communication network over a channel 1208. Communication system 1206 may include a wired and/or wireless communication system. When implemented as a wireless system, system 1200 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. System 1200 includes components and interfaces for mobile telephony.

When implemented as a wired system, system 1200 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

System 1200 or portions thereof may be implemented within one or more integrated circuit dies, and may be implemented as a system-on-a-chip (SoC).

System 1200 may include a user interface system 1210 to interface system 1210.

User interface system 1210 may include a monitor or display 1232 to display information from processor 1204.

User interface system 1210 may include a human interface device (HID) 1234 to provide user input to processor 1204. HID 1234 may include, for example and without limitation, one or more of a key board, a cursor device, a touch-sensitive device, and/or gesture, motion and/or image sensor. HID 1234 may include a physical device and/or a virtual device, such as a monitor-displayed or virtual keyboard.

User interface system 1210 may include an audio system 1236 to receive and/or output audible sound.

System 1200 may further include a transmitter system to transmit signals from system 1200.

System 1200 may correspond to, for example, a computer system, a personal communication device, and/or a television set-top box.

System 1200 may include a housing, and one or more of communication system 1202, digital processor system 1212, user interface system 1210, or portions thereof may be positioned within the housing. The housing may include, without limitation, a rack-mountable housing, a desk-top housing, a lap-top housing, a notebook housing, a net-book housing, a set-top box housing, a portable housing, and/or other conventional electronic housing and/or future-developed housing. For example, communication system 1202 may be implemented to receive a digital television broadcast signal, and system 1200 may include a set-top box housing or a portable housing, such as a mobile telephone housing.

Computer, apparatus, system, and method embodiments are described herein.

A computer embodiment includes a non-transitory computer readable medium encoded with a computer program, including instructions to cause a processor to:

divide a series of data values into groups;

determine, for each group independent of the other groups, a local property that is common among, and is to be used to encode, all of the data values for the given group;

encode each of the data values in each group without a loss in data based on the local property determined for the given group, to produce groups of encoded values; and

associate with each group of encoded values a descriptor indicating the local property determined for the given group.

The instructions cause the processor to divide, determine, and encode cause the processor to perform lossless compression of the data values.

Each of the data values may be represented by a fixed number of bits, and the instructions may further include instructions to cause the processor to:

determine, as the local property, a minimum number of bits required to binary encode each of the data values in the given group without a loss in data; and

binary encode each of the data values in the given group into encoded data values each represented by the determined minimum number of bits.

The instructions may further include instructions to cause the processor to:

determine a maximum data value among the data values in the given group; and

determine, as the minimum number of bits, the minimum number of bits that is sufficiently large to binary encode the maximum data value without a loss of data.

The instructions may further include instructions to cause the processor to:

determine, as the local property, a Rice-Golomb parameter based on the data values in the given group; and

Rice encode each of the data values in the given group based on the determined Rice-Golomb parameter.

The data values may be pixel values from a captured image, and the instructions may further include instructions to cause the processor to:

predict the pixel values to produce predicted error values; and

divide, determine, and encode the predicted error values so as to compress the captured image.

The instructions may cause the processor to:

access the groups of encoded data values and their associated descriptors;

recover the associated descriptors; and

decode the groups of encoded data values without a loss in data using the recovered descriptors.

The instructions may further include instructions to cause the processor to:

determine, for each group separately:

first and second local properties to be used to encode each of the data values for the given group using first and second encoding techniques, respectively; and

which of the first and second encoding techniques, if using the first and second local properties, respectively, would produce a maximum compression of the data values; and

encode each of the data values in each of the groups using, for the given group, the determined one of the first and second encoding techniques, based on the corresponding one of the determined first and second local properties.

The instructions may further include instructions to cause the processor to associate with each group of encoded values a descriptor indicating (i) the determined one of the first and second encoding techniques used to encode the given group, and (ii) a corresponding one of the determined first and second local properties for the given group.

An apparatus embodiment comprises:

a divider to divide a series of data values into groups;

a determiner to determine, for each group independent of the other groups, a local property that is common among, and is to be used to encode, all of the data values for the given group;

a data encoder to encode each of the data values in each group without a loss in data based on the local property determined for the given group, to produce groups of encoded values; and

an associator to associate with each group of encoded values a descriptor indicating the local property determined for the given group.

The divider, the determiner, and the data encoder are configured to operate together to perform lossless compression of the data values.

Each of the data values may be represented by a fixed number of bits;

The determiner may be configured to determine, as the local property, a minimum number of bits required to binary encode each of the data values in the given group without a loss in data; and

The data encoder may be configured to binary encode each of the data values in the given group into encoded data values each represented by the determined minimum number of bits.

The determiner may be further configured to:

determine a maximum data value among the data values in the given group; and

determine, as the minimum number of bits, the minimum number of bits that is sufficiently large to binary encode the maximum data value without a loss of data.

The determiner may be configured to determine, as the local property, a Rice-Golomb parameter based on the data values in the given group; and

The data encoder may be configured to Rice encode each of the data values in the given group based on the determined Rice-Golomb parameter.

The data values may be pixel values from a captured image, and the apparatus may further comprise a predictor to predict the pixel values to produce predicted error values, wherein the divider, the determiner, and the data encoder may be each configured to operate on the predicted error values so as to compress the captured image.

The apparatus may further comprise:

a deformatter to access the encoded groups of data values and recover the associated descriptors; and

a decoder to decode the groups of encoded data values without a loss in data using the recovered descriptors.

The determiner may be configured to determine, for each group separately:
first and second local properties to be used to encode each of the data values for the given group using first and second encoding techniques, respectively; and
which of the first and second encoding techniques, if using the first and second local properties, respectively, would produce a maximum compression of the data values; and

The encoder may be configured to encode each of the data values in each of the groups using, for the given group, the determined one of the first and second encoding techniques, based on the corresponding one of the determined first and second local properties.

The associator may be configured to associate with each group of encoded values a descriptor indicating (i) the determined one of the first and second encoding techniques used to encode the given group, and (ii) a corresponding one of the determined first and second local properties for the given group.

The apparatus may further comprise:

a communication system to communicate with a network;

a computer system including a memory and a processor to interface between the communication system and a user interface system; and

a housing to house the communication system, the memory, the processor, and the user interface system.

The communication system may be a wireless communication.

The housing may include a mobile hand-held housing to further receive a battery.

A method embodiment, comprises:

dividing a series of data values into groups;

determining, for each group separately, a local property that is common among, and is to be used to encode, all of the data values for the given group;

encoding each of the data values in each group without a loss in data based on the local property determined for the given group, to produce groups of encoded values; and

associating with each group of encoded values a descriptor indicating the local property determined for the given group.

The dividing, the determining, and the encoding collectively represent performing lossless compression of the data values.

Each of the data values may be represented by a fixed number of bits;

The determining may include determining, as the local property, a minimum number of bits required to binary encode each of the data values in the given group without a loss in data; and

The encoding may include binary encoding each of the data values in the given group into encoded data values each represented by the determined minimum number of bits

The determining may further include:

determining a maximum data value among the data values in the given group; and

determining, as the minimum number of bits, the minimum number of bits that is sufficiently large to binary encode the maximum data value without a loss of data.

The determining may include determining, as the local property, a Rice-Golomb parameter based on the data values in the given group; and

The encoding may include Rice encoding each of the data values in the given group based on the determined Rice-Golomb parameter.

The data values may be pixel values from a captured image, the method may further comprise:

predicting the pixel values to produce predicted error values; and

performing the dividing, determining, and encoding on the predicted error values so as to compress the captured image.

The method may further comprise:

accessing the groups of encoded data values and their associated descriptors;

recovering the associated descriptors; and

decoding the groups of encoded data values without a loss in data using the recovered descriptors.

The determining may include, for each group separately:

determining first and second local properties to be used to encode each of the data values for the given group using first and second encoding techniques, respectively; and

determining which of the first and second encoding techniques, if using the first and second local properties, respectively, would produce a maximum compression of the data values; and

The encoding may include encoding each of the data values in each of the groups using, for the given group, the determined one of the first and second encoding techniques, based on the corresponding one of the determined first and second local properties.

The associating may include associating with each group of encoded values a descriptor indicating (i) the determined one of the first and second encoding techniques used to encode the given group, and (ii) a corresponding one of the determined first and second local properties for the given group.

Methods and systems disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, and/or a combination of integrated circuit packages. Software may include a computer readable medium encoded with a computer program including instructions to cause a processor to perform one or more functions in response thereto. The computer readable medium may include a transitory and/or non-transitory medium. The processor may include a general purpose instruction processor, a controller, a microcontroller, and/or other instruction-based processor.

Methods and systems are disclosed herein with the aid of functional building blocks illustrating functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the examples disclosed herein.

What is claimed is:

1. A non-transitory computer readable medium encoded with a computer program, including instructions to cause a processor to:
divide a series of data values into groups;
determine, for each group independent of the other groups, a local property that is common among, and is to be used to encode, all of the data values for the given group;
encode each of the data values in each group without a loss in data based on the local property determined for the given group, to produce groups of encoded values; and
associate with each group of encoded values a descriptor indicating the local property determined for the given group.

2. The computer readable medium of claim 1, wherein the instructions to cause the processor to divide, determine, and encode cause the processor to perform lossless compression of the data values.

3. The computer readable medium of claim 1, wherein each of the data values is represented by a fixed number of bits, and the instructions further include instructions to cause the processor to:
determine, as the local property, a minimum number of bits required to binary encode each of the data values in the given group without a loss in data; and
binary encode each of the data values in the given group into encoded data values each represented by the determined minimum number of bits.

4. The computer readable medium of claim 3, wherein the instructions further include instructions to cause the processor to:
determine a maximum data value among the data values in the given group; and
determine, as the minimum number of bits, the minimum number of bits that is sufficiently large to binary encode the maximum data value without a loss of data.

5. The computer readable medium of claim 1, wherein the instructions further include instructions to cause the processor to:
the determine, as the local property, a Rice-Golomb parameter based on the data values in the given group; and
Rice encode each of the data values in the given group based on the determined Rice-Golomb parameter.

6. The computer readable medium of claim 1, wherein the data values are pixel values from a captured image, and the instructions further include instructions to cause the processor to:
predict the pixel values to produce predicted error values; and
divide, determine, and encode the predicted error values so as to compress the captured image.

7. The computer readable medium of claim 1, further including instructions to cause the processor to:
access the groups of encoded data values and their associated descriptors;
recover the associated descriptors; and
decode the groups of encoded data values without a loss in data using the recovered descriptors.

8. The computer readable medium of claim 1, wherein the instructions further include instructions to cause the processor to:
determine, for each group separately:
first and second local properties to be used to encode each of the data values for the given group using first and second encoding techniques, respectively; and
which of the first and second encoding techniques, if using the first and second local properties, respectively, would produce a maximum compression of the data values; and
encode each of the data values in each of the groups using, for the given group, the determined one of the first and second encoding techniques, based on the corresponding one of the determined first and second local properties.

9. The computer readable medium of claim 8, wherein the instructions further include instructions to cause the processor to associate with each group of encoded values a descriptor indicating (i) the determined one of the first and second encoding techniques used to encode the given group, and (ii) a corresponding one of the determined first and second local properties for the given group.

10. An apparatus, comprising:
a divider to divide a series of data values into groups;
a determiner to determine, for each group independent of the other groups, a local property that is common among, and is to be used to encode, all of the data values for the given group;
a data encoder to encode each of the data values in each group without a loss in data based on the local property determined for the given group, to produce groups of encoded values; and
an associator to associate with each group of encoded values a descriptor indicating the local property determined for the given group.

11. The apparatus of claim 10, wherein the divider, the determiner, and the data encoder are configured to operate together to perform lossless compression of the data values.

12. The apparatus of claim 10, wherein:
each of the data values is represented by a fixed number of bits;
the determiner is configured to determine, as the local property, a minimum number of bits required to binary encode each of the data values in the given group without a loss in data; and
the data encoder is configured to binary encode each of the data values in the given group into encoded data values each represented by the determined minimum number of bits.

13. The apparatus of claim 12, wherein the determiner is further configured to:
determine a maximum data value among the data values in the given group; and
determine, as the minimum number of bits, the minimum number of bits that is sufficiently large to binary encode the maximum data value without a loss of data.

14. The apparatus of claim 10, wherein:
the determiner is configured to determine, as the local property, a Rice-Golomb parameter based on the data values in the given group; and
the data encoder is configured to Rice encode each of the data values in the given group based on the determined Rice-Golomb parameter.

15. The apparatus of claim 10, wherein the data values are pixel values from a captured image, the apparatus further comprising a predictor to predict the pixel values to produce predicted error values, wherein the divider, the determiner, and the data encoder are each configured to operate on the predicted error values so as to compress the captured image.

16. The apparatus of claim 10, further comprising:
a deformatter to access the encoded groups of data values and recover the associated descriptors; and
a decoder to decode the groups of encoded data values without a loss in data using the recovered descriptors.

17. The apparatus of claim 10, wherein:
the determiner is configured to determine, for each group separately:
first and second local properties to be used to encode each of the data values for the given group using first and second encoding techniques, respectively; and
which of the first and second encoding techniques, if using the first and second local properties, respectively, would produce a maximum compression of the data values; and
the encoder is configured to encode each of the data values in each of the groups using, for the given group, the determined one of the first and second encoding techniques, based on the corresponding one of the determined first and second local properties.

18. The apparatus of claim 17, wherein the associator is configured to associate with each group of encoded values a descriptor indicating (i) the determined one of the first and second encoding techniques used to encode the given group, and (ii) a corresponding one of the determined first and second local properties for the given group.

19. The apparatus of claim 10, further comprising:
a communication system to communicate with a network;
a computer system including a memory and a processor to interface between the communication system and a user interface system; and
a housing to house the communication system, the memory, the processor, and the user interface system.

20. The apparatus of claim 19, wherein the communication system is a wireless communication.

21. The apparatus of claim 19, wherein the housing includes a mobile hand-held housing to further receive a battery.

22. A machine implemented method, comprising:
dividing a series of data values into groups;
determining, for each group separately, a local property that is common among, and is to be used to encode, all of the data values for the given group;
encoding each of the data values in each group without a loss in data based on the local property determined for the given group, to produce groups of encoded values; and
associating with each group of encoded values a descriptor indicating the local property determined for the given group.

23. The method of claim 22, wherein the dividing, the determining, and the encoding collectively represent performing lossless compression of the data values.

24. The method of claim 22, wherein:
each of the data values is represented by a fixed number of bits;
the determining includes determining, as the local property, a minimum number of bits required to binary encode each of the data values in the given group without a loss in data; and
the encoding includes binary encoding each of the data values in the given group into encoded data values each represented by the determined minimum number of bits

25. The method of claim 24, wherein the determining further includes:
determining a maximum data value among the data values in the given group; and
determining, as the minimum number of bits, the minimum number of bits that is sufficiently large to binary encode the maximum data value without a loss of data.

26. The method of claim 22, wherein:
the determining includes determining, as the local property, a Rice-Golomb parameter based on the data values in the given group; and
the encoding includes Rice encoding each of the data values in the given group based on the determined Rice-Golomb parameter.

27. The method of claim 22, wherein the data values are pixel values from a captured image, the method further comprising:
predicting the pixel values to produce predicted error values; and
performing the dividing, determining, and encoding on the predicted error values so as to compress the captured image.

28. The method of claim 22, further comprising:
accessing the groups of encoded data values and their associated descriptors;
recovering the associated descriptors; and
decoding the groups of encoded data values without a loss in data using the recovered descriptors.

29. The method of claim 22, wherein:
the determining includes, for each group separately:
determining first and second local properties to be used to encode each of the data values for the given group using first and second encoding techniques, respectively; and
determining which of the first and second encoding techniques, if using the first and second local properties, respectively, would produce a maximum compression of the data values; and
the encoding includes encoding each of the data values in each of the groups using, for the given group, the determined one of the first and second encoding techniques, based on the corresponding one of the determined first and second local properties.

30. The method of claim 22, wherein the associating includes associating with each group of encoded values a descriptor indicating (i) the determined one of the first and second encoding techniques used to encode the given group, and (ii) a corresponding one of the determined first and second local properties for the given group.
